(19) United States
(12) Patent Application Publication
(10) Pub. No.: US 2016/0351070 A1
(43) Pub. Date: Dec. 1, 2016

(54) MOBILE HEALTH SYSTEM AND DEVICE

(71) Applicant: Lara Aillon-Sohl, Pittsfield, MA (US)

(72) Inventor: Lara Aillon-Sohl, Pittsfield, MA (US)

(21) Appl. No.: 15/166,452

(22) Filed: May 27, 2016

Related U.S. Application Data
(60) Provisional application No. 62/168,458, filed on May 29, 2015.

(51) Int. Cl. G09B 19/00; H04M 3/493; H04M 1/725; H04W 4/18

(52) U.S. Cl. CPC G09B 19/00; H04W 4/18; H04M 3/493; H04M 1/72519

(57) ABSTRACT

Systems and methods may be provided for changing an action of a user using electronic input. The systems and methods may send a first text message to request the user to set a specific short-term target for a day based on the long-term target and ascribed value. The systems and methods may later send a second text message to request the user to adjust the specific short-term target for the day, wherein the user may adjust the specific short-term target based on evaluating his/her current progress toward the short-term target. The systems and methods may then send a third text message to inquire whether the adjusted short-term target for the day is met by the user, wherein the user may send a reply text message to confirm or deny the short-term being met. The systems and methods may send a response to the reply message, and may record the reply to display the user's progress in visual representation.

### RELATED APPLICATION

This application claims the benefit of U.S. Provisional Application No. 62/168,458, filed on May 29, 2015. The entire teachings of the above application is incorporated herein by reference.

### BACKGROUND

Each year, millions of Americans hope to change actions (e.g., behavior) that negatively impact their health and well-being. Despite their best intentions and best efforts, only a minority of Americans are able to replace bad habits with good ones. The vast majority of Americans fails not because of a lack of willpower or a character flaw, but because they do not recognized that behavioral change is a biological process. As a biological process, behavioral change requires embedding new learning in the context of an individual's personal psychology, which is influenced by the individual's thoughts and emotions.

### SUMMARY

Although changing the actions (behavior) of an individual is a complex process, such changes are also predictable and controllable. The social science of behavioral modification subscribes to the need for target setting, self-monitoring, feedback, reinforcement, incentives, stimulus control, cognitive restructuring, and social relatedness and support. Neuroscience provides evidence that with focused attention and repetition of new thinking and new actions, the brain establishes new neural pathways, known as neuroplasticity, which aid in forming new habits. Additionally, recent neurological evidence shows that a localized area of the brain, known as the ventromedial prefrontal cortex, increases its activity when an individual ascribes a value to an idea and reflects on core values, resulting in the individual being more likely to engage in sustained behavioral change.

Further, emerging scientific evidence suggests that a mobile device may be a useful means for health promotion and disease prevention. For example, in the spring of 2014, the U.S. Department of Health and Human Services concluded that there was strong evidence to support text messaging as a means for changing the actions of a user that improves clinical care outcomes. In this way, the actions that may be changed by the use of text messaging may include: weight loss, sedentary lifestyle, stress management, procrastination, smoking cessation, substance dependence, and medication adherence. Such changed behavior may improve an individual's wellbeing, reduce disability, and reduce health care costs.

The present disclosure comprises a mobile health system and device empirically grounded in human psychology, behavioral science, and neuroscience, which facilitates meaningful and long lasting changes in one or more actions of the user. The mobile health system and device may utilize text messaging, such as SMS text messaging, in a manner specifically designed to promote the essential components of such changes: target setting, focused awareness, repetition, self-monitoring, feedback, reinforcement, and incentives. For example, the mobile health system and device enables a user to provide long-term targets, which are used by the system to determine timing and content of text messages sent to the user to set and adjust short-term targets toward reaching a long-term target of the user. The mobile health system and device may be configured in a web-based infrastructure that includes a website providing a social supportive environment of compassion, encouragement, and education. Some embodiments of the present disclosure also address the further technical issue of automatically displaying a visual representation of progress toward the long-term target and automatically controlling health and fitness devices to account for changing short-term targets of the user. In these embodiments, the mobile health system and device may enable displaying formatted data and programming of health and fitness related applications and devices based on the timing and context of text messages setting short-term targets and adjusting the short-term targets toward reaching the long-term target.

The present disclosure is directed to systems and methods for changing actions of a user. The systems and methods may record a long-term target and an ascribed value associated with the long-term target for changing the actions of the user. The systems may include a service client configured to input (e.g., by a user or another system) a long-term target and ascribed value, and a mobile health engine, communicatively coupled to the service client, configured to record the input long-term target and ascribed value. The service client may be a web client, a voice client, an email client, or any other such client capable of communicating user input. In some embodiments, the mobile health engine may be a web-based engine that includes at least one of a web server, an application server, a database server, and an application database. In other embodiments, the mobile health engine may include a voice-based engine that includes at least one of an interactive voice response (IVR) device and a telephony server. In yet other embodiments, the mobile health engine may be a combined web-based and voice-based engine.

The systems and methods may send a plurality of messages over a period of time to the user, wherein content of each of the plurality of messages may be generated based on the long-term target and the ascribed value. In some embodiment, timing of each of the plurality of messages may also be determined based on the long-term target and the ascribed value. In some embodiments, the systems and methods may send the plurality of messages in intervals of the period of time, such as three times per day. The systems may include a mobile client communicatively coupled to the mobile health engine, such that the mobile client receives and displays the messages sent to the user from the mobile health engine, and may also send messages from the user back to the mobile health engine. The messages may be text messages, voice messages, email messages, or any other type of message that may be communicated to a mobile client.

In these embodiments, the systems and methods may send a first message for reminding the user of the long-term target and ascribed value, and requesting the user to set a specific short-term target for the interval based on the long-term target and ascribed value. In some embodiments, the systems and methods may further send a second message for requesting the user to adjust the specific short-term target for the interval, wherein the user may adjust the specific short-term target based on evaluating his/her current progress toward the short-term target. In some of these embodiments, the systems and methods may then send a third message for inquiring whether the adjusted short-term target is met by the user for the interval, wherein the user may send a reply message to confirm or deny the short-term being met. The systems and methods may send a response to the reply message of the user and may also record the reply. The systems and methods may receive the adjusted short-term target of the user and confirm or deny reply, via the mobile health engine, for visual representation on a graphical user interface. In some embodiments, the system and methods may display the visual representation to include progress of the user toward reaching the long-term target, which may be generated based on the recorded reply for each interval of the period of time. The visual representation may be displayed (by the mobile health engine) using various electronic graphical user interfaces private to the user, including on a private user webpage. In some embodiments, the systems and methods may further program at least one of a health related application and a health related device based on the timing and context of the text messages setting the short-term target and adjusting the short-term target.

### BRIEF DESCRIPTION OF THE DRAWINGS

The foregoing will be apparent from the following more particular description of example embodiments of the disclosure, as illustrated in the accompanying drawings in which like reference characters refer to the same parts throughout the different views. The drawings are not necessarily to scale, emphasis instead being placed upon illustrating embodiments of the present disclosure.

FIG. 1A is a schematic diagram of an example computer network environment in which embodiments of the disclosure are deployed.

FIG. 1B is a block diagram of certain components of the computer nodes in the network of FIG. 1A.

FIG. 1C is a block diagram of the network of FIG. 1A configured in an example embodiment as a web-based system.

FIG. 1D is a block diagram of the network of FIG. 1A configured in an example embodiment as an interactive voice response (IVR) system.

FIG. 2A is a flow chart depicting an example process for setting action related targets in embodiments of the disclosure.

FIG. 2B is a sequence diagram depicting an example process for changing a user's actions in embodiments of the disclosure.

FIG. 2C is a sequence diagram depicting an example process of generating improved notifications to users with respect to long-term and short-term targets of users in embodiments of the disclosure.

FIGS. 3A-3F illustrate example web interfaces for the mobile health system in an example embodiment of the disclosure.

FIGS. 4A-4B illustrate an example database for the mobile health system in an example embodiment of the disclosure.

### DETAILED DESCRIPTION

A description of example embodiments of the disclosure follows.

### Digital Processing Environment

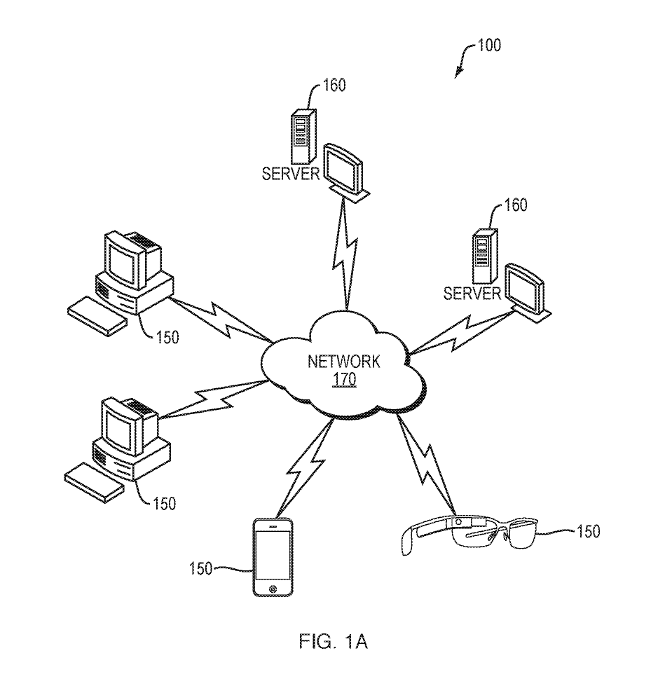

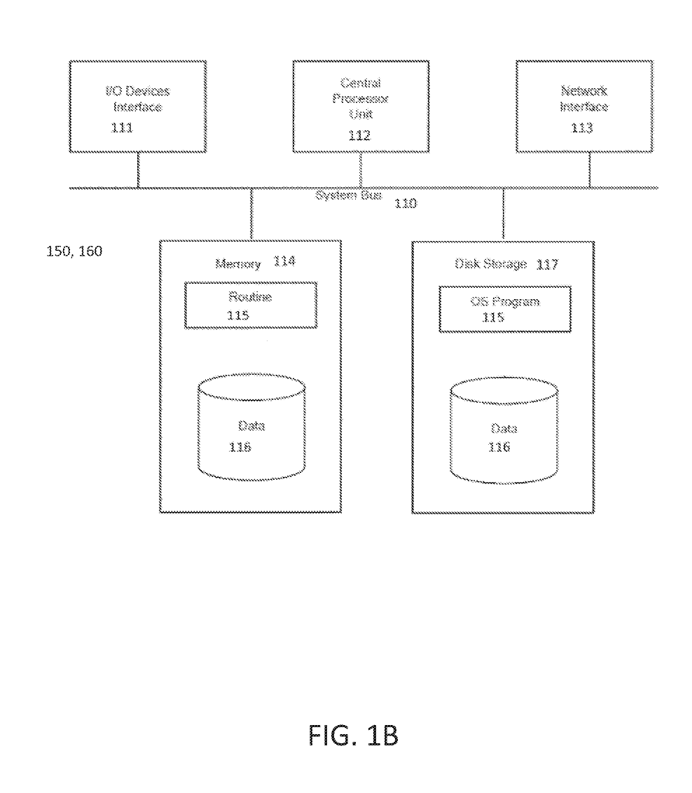

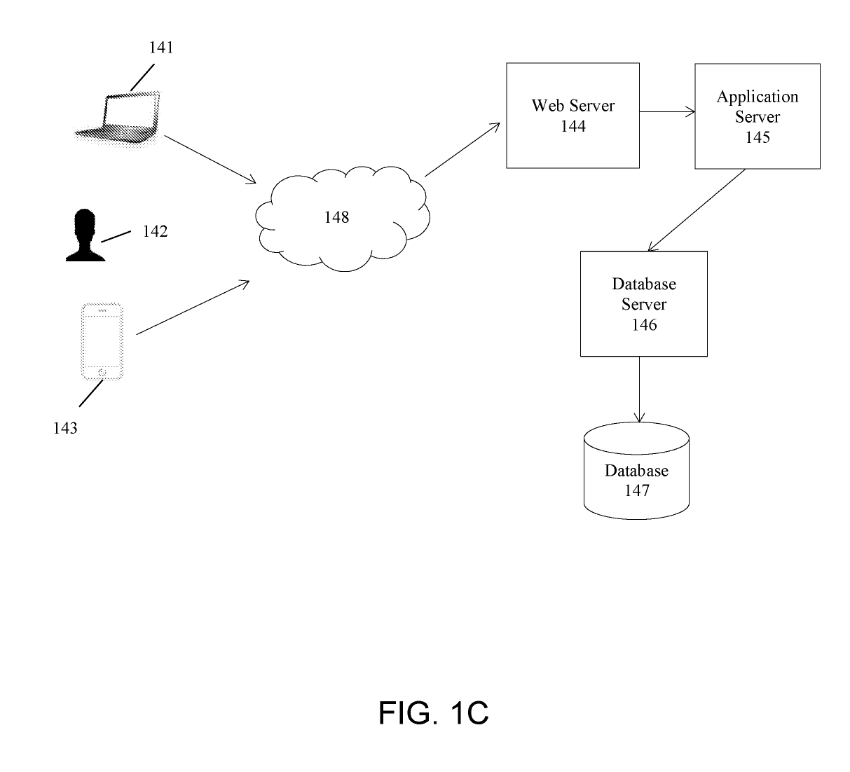

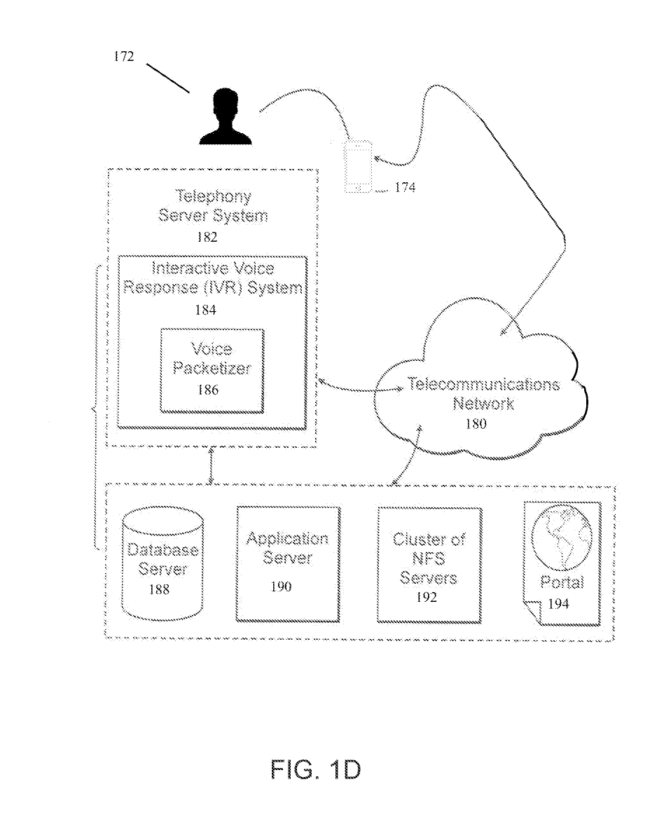

Example implementations of a mobile health system/device 100 may be implemented in a software, firmware, or hardware environment. FIG. 1A illustrates one such example digital processing environment in which embodiments of the present disclosure may be implemented. Client computers/devices 150 and server computer/devices 160 (or a cloud network 170) provide processing, storage, and input/output devices executing application programs and the like.

Client computers/devices 150 may be linked directly or through communications network 170 to other computing devices, including other client computers/devices 150 and server computer/devices 160. The communication network 170 can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network 170 may take a variety of forms, including, but not limited to, a data network, voice network (e.g. land-line, mobile, etc.), audio network, video network, satellite network, radio network, and pager network. Other electronic device/computer networks architectures are also suitable.

Client computers/devices 150 may be mobile health clients (e.g., web clients, text message clients, voice clients) configured on computing devices, such as laptops, PCs, tablets, mobile devices, or any other such computing device. Server computers 160 may comprise a mobile health engine, which communicates with client devices 150, such as the mobile health clients, for changing the health related actions of a user of the mobile health system/device. In some embodiments, the client 150 may be implemented as a mobile health device in accordance with one or more example embodiments described herein.

The server computers may not be separate server computers but part of cloud network 170. The mobile health clients 150 may communicate information regarding a user's actions to the mobile health engine 160. In some embodiments, the mobile health clients 150 may include client applications executing on the computing devices 150 for connecting with the mobile health engine 160 to register the user for mobile health services, provide a user's action targets, and view a user's progress toward his/her action targets. In these and other embodiments, the mobile health clients 150 may include client applications executing on the computing devices 150 for receiving, displaying, responding to action related messages from the mobile health engine 160 (e.g., setting and adjusting short-term targets), and programming other health related applications on computing devices 150 and health related devices 150 based on the set and adjusted short-term targets. In some embodiments, the mobile health engine 160 may include server applications for analyzing behavioral information for a user, sending behavioral related messages to the mobile health clients 150, and programming the health related applications and devices 150 based on the behavioral related messages.

FIG. 1B is a simplified block diagram of any internal structure of a computer/computing node (e.g., client processor/device 150 or server computers 160) in the processing environment of FIG. 1A, which may be used to facilitate processing audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

Attached to the system bus 110 is an I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of the present disclosure.

Software components 115, 116 of the mobile health system/device described herein may be configured using any programming language, including any high-level, object-oriented programming language and any web-based scripting language (e.g., PHP and HTML).

The server may include instances of the mobile health system/device 100 (e.g., FIGS. 1C and 1D), which can be implemented as a client 150 (e.g., mobile health client) that communicates to the server 160 (e.g., mobile health engine) utilizing various means, including encrypted data packets (e.g., via SSL), and may contain information regarding the user's action targets. In addition, the system may include other instances of client processes executing on other client computers/devices 150, such as a client application that may communicate (e.g., via HTTP) with the server (e.g., mobile health engine) to configure long-term targets and message parameters (e.g., behavioral information) for communicating text messages (e.g., via SMS) to the user. In some embodiments, the computing device 150 for configuring the parameters may be implemented via a software embodiment and may operate, at least partially, within a browser session.

In an example mobile implementation, a mobile agent implementation of the disclosure may be provided. A client-server environment may be used to enable mobile configuration of the mobile health client 150 or mobile health engine 160. It can use, for example, the XMPP protocol to tether a configuration server 115 on a device 150 to the mobile health system/device 160 or mobile health client 150. The server 160 can then issue commands via the mobile phone on request. The mobile user interface framework to access certain components of the system 100 may be based on XHP, Javelin, SMS and WURFL. In another example mobile implementation for OS X, iOS, and Android operating systems and their respective APIs, Cocoa and Cocoa Touch may be used to implement the client side components 115 using Objective-C or any other high-level programming language that adds Smalltalk-style messaging to the C programming language. The system may also include instances of server processes on the server computers 160 that may comprise a mobile health engine, which allows for analyzing a user's configured action targets and sending action related messages. The system may also include instances of server processes which analyze a user's configured action targets and send action related messages to the mobile health clients.

Disk storage 117 provides non-volatile storage for computer software instructions 115 (equivalently “OS program”) and data 116 used to implement embodiments of the system 100. The system may include disk storage accessible to the server computer 160. The server computer (e.g., mobile health engine) or client computer (e.g., mobile health client) may store a user's action related targets and message communication preferences. Central processor unit 112 is also attached to the system bus 110 and provides for the execution of computer instructions. Software implementations 115, 116 may be implemented as a computer readable medium capable of being stored on a storage device 117, which provides at least a portion of the software instructions for the mobile health system/device. Executing instances of respective software components of the mobile health system/device, may be implemented as computer program products 115, and can be installed by any suitable software installation procedure, as is well known in the art. In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present mobile health system/device 100 of FIG. 1A.

### Web Service System

FIG. 1C is a block diagram of an example implementation of the mobile health system/device 100 of FIG. 1A. In the example configuration in FIG. 1C, a web-based mobile health system/device is provided. The system includes a web service client executing on a computing device 141 or mobile device 143. A user 142 many generate a web request via the computing device 141 or the mobile device 143 to perform a mobile health related transaction, such as registering for mobile health services or configuring action (e.g., behavioral) related information. The user 142 many generate the web request by entering a uniform resource locator (URL) into a web browser or selecting a mobile health icon which generates the URL for the user 142. In some embodiments, the web client executing on the computing device 141 or mobile device 143 may transmit the web request as a HTTP Request containing the URL. In other embodiments, the web client may use another protocol similar to HTTP to transmit the web request, which may contain a URL or another such resource locator format. The web client may send the request over the network 148 to the mobile health engine comprised of web server 144, application server 145, database server 146, and web application database 147.

The web server 144 may receive the web request, and in turn, may send the web request to the application server 145 for further processing. The application server 145 may include a directory structure of scripting language files for web applications (e.g., PHP, HTML, CGI, Ruby, Python, or Java), which contain methods for web applications executing on the application server 145 to process the web request. As part of processing the request, the application server 145 may display (via the web server 144), a web interface for the user to provide information (e.g., name, username, password, phone number, email address, behavioral related information, and such) to register with the mobile health system/device. The web client (via the computing device 141 or the mobile device 143), web server 144, and application server 145 may exchange additional web requests and web responses for the user to register with the mobile health system/device using the web interface. The application server 145 may transmit the information received during the user registration process to the database server 146 to be stored as records in the web application database 147. Similarly, the application server 145 may display (via the web server 144) additional web interfaces for the user to provide action targets to the mobile health system/device, provide message communication parameters, and to view the progress of his/her action targets.

A web application (e.g., Twilio) executing on the application server 145 may then analyze the action targets provided by the user. That is, the web application may use the scripting language files, along with the records in the web application database 147, to generate text messages, such as short message server (SMS) text message, to send the user based on the action targets provided by the user. The web application may also analyze some or all of the user-provided action targets, message communication parameters, and behavioral information of the user to determine timing, frequency, content, and such of the text messages sent to the user. The web application may use standardized mobile communication protocols to transmit the text messages to the user 142 via mobile device 143 at the determined times. The user 142 may view the text messages and may respond to one or more of the text messages via a standard text message interface on the mobile device 143. The mobile device 143 may transmit responses to the one or more text messages back to the application server 145 using the standardized mobile communication protocols. The web application executing on the application server 145 may receive the text message response and perform various actions, such as storing information from the text message web application database 147, communicating further with the user 142 via another text message, or programming, or otherwise controlling, the function of one or more health/fitness applications, such as executing on computer devices 141 or 142, or physical health/fitness devices in accordance with the user's action targets (including timing, frequency, and content).

### Interactive Voice Response (IVR) System

FIG. 1D is a block diagram of an example implementation of certain components of the system 100 of FIG. 1A. In the example configuration in FIG. 1D, an interactive voice response (IVR) system 184 is provided. In this embodiment, the mobile health system/device 100 is based on interactive voice response (IVR) technology. IVR is a telephony technology in which a user uses a touch-tone phone, speech recognition, or a mobile app to interact with a database to acquire information from the database or to enter data into the database. The user 172, via a voice device 174 (e.g. mobile phone, landline phone, video phone), may transmit a request (e.g. make a phone call) to provide action targets at the mobile health system/device. The request may be received by the telephony server system 182 through the telecommunication network 180. The telephony server 182, may access information contained in the request, such as the destination phone number, and based on this information, may respond by prompting the user for login information (e.g. name, username, password, pin code). Once the user enters the login information, the telephony server 182, transfers this information out a port to an application server 190, implemented using a conventional application server computer platform and executing a standard application server operating system that provides for the execution of phone application programs.

The application server 190 may then pass this information to the database server 188 for further processing. The database server 188 may verify that the login information corresponds to an active account and provide this information back to the application server 190. Based on this response, the application server 190 may communicate to the telephony server 182 to prompt the user to enter (e.g., speak) a long-term action target, an ascribed value, a short-term action target, message communication parameters, behavioral information, and such, which may be transferred out the port to the application server 190. In this manner, the application server 190 may request such information from the user through the telephony server 182. The application server 190 may communicate this information, to the database server 188 or cluster of NFS servers 192 for storage as records or files.

At a later time, the application server may communicate with the database server 188 or cluster of NFS servers 192 for retrieving the records or files. In some embodiments, the web application may analyze user-provided action targets, and other user-provided information, to determine times to provide messages to the user, frequency of the messages, and content of the messages. Using the information from the retrieve records or files, the application server 190 may request the telephony server system to communicate across the telecommunication network 180 to contact the user 172 via voice devices 174 (e.g. mobile phone, landline phone, video phone) to provide messages to the user regarding the action target. In some embodiments, the user may be contacted directly with the messages, and in other embodiments, the messages may be communicated to a voicemail system, or other message system, configured for the user's voice devices. If the message is communicated directly to the user 172, via the voice device 174, the user 172 may communicate a response to the telephony server system 182 (e.g. using the device keypad, device app, or speech); the response may be a “yes” or “no” response or longer voice response that may be communicated back to the application server 190 for storage via the database server 188 or cluster of NFS servers 192.

Using the information from the retrieve records or files, the application server 190 may instead generate text messages, such as short message server (SMS) text message, to send the user regarding the action target. The application server 190 may use portal 194 to transmit the text messages across the telecommunication network 180 using standardized mobile communication protocols to contact the user 172 via mobile devices 174 (e.g., mobile phone). The user 172 may view the text messages and may respond to one or more of the text messages via a standard text message interface on the mobile device 174. The response may be a “yes” or “no” response or longer text response that may be communicated back to the application server 190 for storage via the database server 188 or cluster of NFS servers 192.

The telephony server system 182 may execute a computer telephony integration application that, in combination with the voice packetizer 186, preferably implements the interactive voice response (IVR) system 184 that allows the telephony server system 182 to effectively handle and respond to the voice communications.

### Scientific Overview of Changing a User's Actions

Embodiments of the present disclosure utilize the science of transtheoretical model of change, see, e.g., “Transtheoretical Model of Change” (Prochaska & DiClemente 1983) and “Self Determination Theory” (Deci & Ryan 1985), which identifies six necessary stages of change. In this model, the task of moving from one stage to the next stage is often the greatest challenge for affecting change. These embodiments promote and enhance the stages of preparation, action, and maintenance for change by supporting decision making, promoting self-efficacy, and enhancing the process of change. To support decision making the user of these embodiments (e.g., via a mobile health engine) is prompted to create a long term target with attached meaning (e.g., ascribed value) to align the user's values to the created target, resolving ambivalence and ignite motivation. Once the long term target has been set, the user is tasked with creating specific and manageable short-term targets in accordance with preference and personality. Such setting of targets boost a sense of self-efficacy and mastery that decrease the temptation to return to old actions (e.g., behaviors) and diminish the experience of guilt and shame that often accompany failure, and gives the user a sense of choice and volition in the short-term targets that increases motivation and an experience of competence when met. The short-term targets can be substitutes for old behaviors, which is an example of counter-conditioning, an important aspect in the process of change. These embodiments also identify the need for positive reinforcement and helping relationships in the process of change, to increase the probability that healthy responses will be repeated. Specifically, these embodiments send text message, for specifying and managing the short-term targets, crafted to promote the change process, which providing a compassionate and helping voice to prompt a user to recall the user's long term target and to act on the user's short-term target for the day. In some embodiments, the sending of these text messages may be configured (e.g., timing, frequency, content, etc.) based on the specific long-term target of the user, stage of the user in reaching the target, neurobiological information related to the user, and such.

Specifically, behavior change requires efforts to move a user to act and to sustain the effort toward a long-term target. Behavior change is a dynamic process that occurs on the neurobiological level, and the brain has the capacity to reorganize itself by forming new neural connections throughout life. The brain does so by proliferating cells, enhancing synapses (connections), reconsolidating memories, and altering neurotransmitter messenger activity. This process, known as neuroplasticity, is necessary for learning and embedding new patterns of emotions, thoughts and behaviors. In an effort to be efficient the brain converts a sequence of action into an automatic routine known as “chunking” and is at the root of how habits form, and when a habit forms, the brain stops fully participating in decision making. Habits can be unconsciously created and they can also be deliberately designed. Healthy behaviors that promote satisfying outcomes engage the reward-motivation system that is governed by neurotransmitters that will assist in embedding the memory and increasing the desire and motivation to repeat the behavior. Healthy habits that are deliberately designed make change possible by freeing individuals from decision making and relying on self-control.

Embodiments of the present disclosure facilitate success embedding of new healthy actions of the user, which are deliberately designed, by encouraging the completion of specific and manageable short-term targets. In some example embodiments, the mobile health engine enables the user to select the short-term targets based on prompting the user in accordance with the provided long-term targets of the user, and, in some embodiments, determined stage of the user in reaching the target and neurobiological data of the user (e.g., by collecting and analyzing neurobiological related data of the user). For instance, in these example embodiments, timing, content, frequency, and such of the text messages may be determined based on collecting and analyzing data related to the specific long-term target specified by the user and related to neurobiological data of the user (medical, psychological, and such data from tests, questionnaires, and such) to embed new patterns in a manner tailored to the user. Each successful completion of a short-term target, as may be acknowledged by the prompting by a specifically formulated text message, activates the reward-motivation system in the brain that leverages small advances into patterns of actions/behavior. Further, by allowing the user to monitor their progress (e.g., on a visual interface, which may be presented in a preferred format based on determined neurobiological data of the user, or by automatically programming a health related application or device utilized by the user), the new actions are rewarded and reinforced.

### Setting Action Related Targets

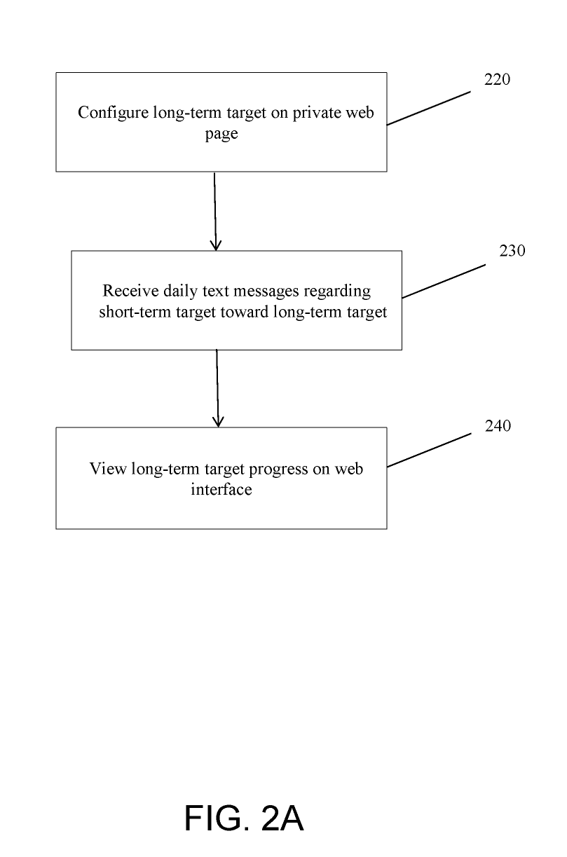

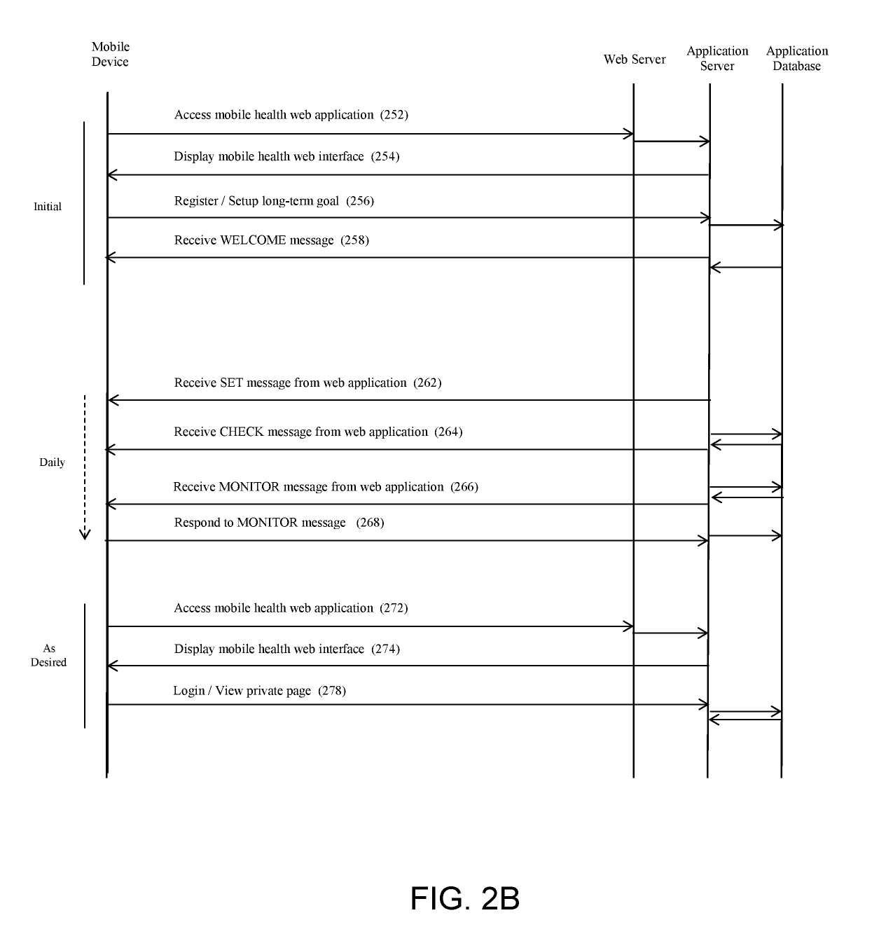

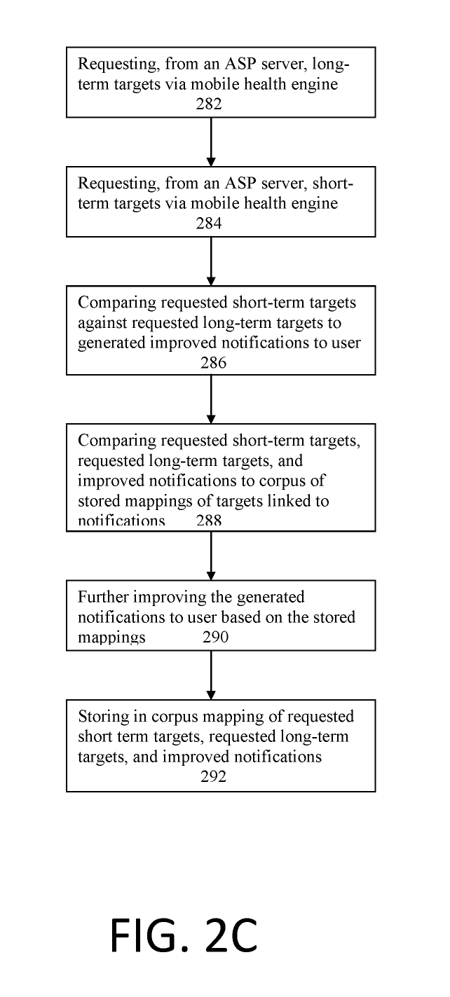

FIG. 2A is a flow chart depicting an example process for setting action related targets in embodiments of the disclosure. The example process is directed to embedding new learning in the context of a user's personal psychology and neurobiological data, influenced by the user's thoughts and emotions, to change a particular action (e.g., behavior) of the user. The example process uses the components of target setting, focused awareness, self-monitoring, repetition, feedback, reinforcement, incentives, stimulus control, cognitive restructuring, and social support to embed the new learning in the user's personal psychology.

The process at step 220 first requires the user to configure a long-term target for changing a particular action. The setting up of the long-term target may require the user to specify a category of action changes that align to the user's long-term target (e.g., weight loss, exercise, financial health, procrastination, smoking cessation, addiction, and such), which may be used to formulate text messages designed specifically (content, timing, etc.) based on these targets. The act of configuring the long-term target encourages the components of target setting and focused awareness for embedding new learning to change the particular action. In some embodiments, the long-term target may be specified through a private web page or other electronic interface private to the user. In other embodiments, the long-term target may be specified using various other mediums, including through a voice message, text message, email, or any other such mediums. In some embodiments, the long-term target may be a clinic target, such as weight loss, sedentary lifestyle, stress management, procrastination, smoking cessation, substance dependence, medication adherence, or other such clinic target. In other embodiments, the long-term target may be another desired achievement of the user, such as achieving better academic grades, achieving better finances, or traveling to an exotic destination.

The process at step 220 may further require the user to specify an ascribed value or reason associated with the long-term target, which may further encourage the components of target setting and focused awareness for embedding new learning to change the particular action (as the user may choose with personal meaning and value that increase motivation). The value or reason may also be specified using the same or different medium as specifying the long-term target. For example, the user may specify on the user's private web page: “I want to lose 10 lbs.” with the user's ascribed value for the reaching the target: “so that I can have more energy to play with my kids.” The user's specified target and ascribed value for the target may be recorded at a mobile health engine, or other mobile health subsystem, for the mobile health system/device to further analyze and interact with the user regarding the long-term target and ascribed value associated with the long-term target. The process at step 220 may also communicate with device sensors, computing applications, databases, and such to collect further information regarding the user (e.g., personality, psychology, medical, fitness, financial, and such as may be determined from tests, questionnaire, and such), which may further be recorded at the mobile health engine.

After specifying the long-term target, the user receives daily text messages 230 regarding short-term targets towards the user's specified long-term target. The mobile health engine, or other mobile health subsystem, may send one or more text messages to the user daily. In other embodiments, the mobile health engine may send other types of messages, such as voice messages, and the messages may be sent at different intervals, such as bi-daily, bi-weekly or weekly. In some embodiments, the user or system administrator may configure message parameters, such as the number of messages, the content of each message, the timing for sending each message, and the duration for sending the messages, at the mobile health engine. In other embodiments, a behavioral professional (e.g., doctor or therapist) may configure these message parameters at the mobile health engine based on analyzing the long-term target and ascribed value, and any other information (e.g., psychological, neurobiological, and such) recorded regarding the user. In other embodiments, the mobile health engine may include applications that utilize algorithms for analyzing the long-term target, ascribed value, and recorded data of the user to automatically determine these message parameters. The automatically determined message parameters may dynamically change as the user progresses towards a long-term target, as indicated by the recorded data being updated with results of the short-term targets. In yet other embodiments, the message parameters may be determined by a combination of these embodiments.

For example, the analyzing of the long-term targets, ascribed values, and other provided data of the user, either automatically or by a behavioral professional, may be performed based on principles of human psychology, behavioral science, neuroscience, and other behavior related sciences to facilitate meaningful and long lasting behavioral change in a manner specific to the user. The analyzing may result in different message parameters based on the particular long-term target and the particular ascribed value associated with the long-term targets. This is because the mobile health system/device may recognize that embedding new learning regarding one action may be influenced by different thoughts and emotions than embedding new learning regarding a second action, or even regarding the same action if based on a different ascribed value. For instance, different messages may be more effective for changing weight loss behavior than for changing stress management behavior. In addition, different messages may be more effective for weight loss if the ascribed value is “to have more energy to play with my kids” rather than if the ascribed value is “to look better in a swimsuit.” Further different messages may be more effective based on the stage of the user in reaching the target and the recent neurobiological data of the user.

The mobile health engine may send daily text messages requiring the user to specify a short-term target for the day. The message parameters, such as the content of the message and the timing of the message, may be determined based on one or more of the described embodiments. In some embodiments, the user may respond to the text message with the short-term targets, which the mobile health engine may record. The act of specifying the short-term target may encourage the components of target setting and focused awareness for embedding new learning to change the particular action. In some embodiments, the content and timing of the message may also encourage these components, and may further influence the thoughts and emotions of the user in regards to changing the action related to the long-term target. In addition, the use of text messages, in some embodiments of the present disclosure, to send these messages, addresses the technical challenge of alerting a user to set/adjust these targets consistently, as these targets change, in a timely and accurate manner, and providing the user a medium to provide the targets back to the mobile health engine. Specifically, other solutions that request fitness/health information from a user may depend on the user to log into or view a particular interface or application to provide such information. The user will not be alerted to doing so (or not as overtly alerted as a text message on a mobile device) and, thus, will likely not do so at daily intervals as necessary learning and embedding new patterns of actions/behavior. Thus, the use of text messages (in part as alerts) addresses the technical issue of ensuring the processing of health/fitness data that reflects the present state/target of the user.

The mobile health engine may also send daily text messages requiring (alerting) the user to adjust the specified short-term target. The message parameters, such as the content of the message and the timing of the message, may be determined based on one or more of the described embodiments. In some embodiments, the user may respond to the text message with the adjusted short-term targets, which the mobile health engine may record. The act of adjusting the short-term target may encourage the components of self-monitoring and reinforcement for embedding new learning to change the particular action. In some embodiments, the content and timing of the message may also encourage these components, and may further influence the thoughts and emotions of the user in regards to changing the action related to the long-term target.

The mobile health engine may also send daily text messages requesting the user to report the status of whether the adjusted short-term target is met. The message parameters, such as the content of the message and the timing of the message, may be determined based on one or more of the described embodiments. In some embodiments, the user may simply confirm or deny the adjusted short-term target being met (e.g., “yes” or “no”), and in other embodiments, the user may provide further information regarding meeting the adjusted short-term target. The user responding accordingly to the text message may result in the mobile health engine further replying with a text message containing various contents, such as encouragement for the user, feedback for the user, or incentives for the user to continue progressing toward the long-term target. The reply message parameters, such as the content of the message and the timing of the message, may be determined based on one or more of the described embodiments. In some embodiments, the mobile health engine and the user may exchange further text messages regarding meeting the short-term target. The act of reporting the status, and receiving a related reply, may encourage the components of self-monitoring, feedback, and incentives for embedding new learning to change the particular action. The mobile health engine sending these messages daily, or at another constant periodic interval, may further encourage the components of repetition, stimulus control, and cognitive restructuring.

The mobile health engine may be configured to further communicate with health/fitness applications (e.g., apps on a mobile device or other computing device) or a health/fitness device, so as to program or control the health/fitness application or device based on the setting, adjusting, and meeting of short-term targets. Various health/fitness application and devices exist in the art, but they do not automatically account for changing short-term targets of the user (e.g., numerous times daily), and do so based on behavioral science that determines the timing, frequency, and content of these changes particular to an individual user. In some embodiments, the mobile health engine may communicate to program, or otherwise control, these health fitness application/devices, to operate based on the changing short-term targets (or meeting the short-term targets) of the user, in accordance with the timing and content determined by the mobile health engine according to the actions (behaviors) particular to the user. For example, as the user's short-term weight lose targets change, based on scientifically determined text messages prompting the using to set/adjust the user's weight loss targets, the mobile health engine may control a weight loss application or device to adjust the user's configured required calorie intake or required fitness routine (e.g., steps walked) for the day. For another example, as the user's short-term financial targets changed, the mobile health engine may control a financial application or device to adjust the user's investments or automatic account charges.

The mobile health engine may communicate with the application and device through existing interface (APIs, URLs, login interfaces using user's username/password, and such), which may be currently executed to instead enable a user to manually provide similar information. Note, the user providing this information manually does not ensure the frequency and accuracy of controlling the application or device based on the user's changing short-term targets determined for the particular user at consistent intervals and in accordance with scientific methods. As such, the mobile health engine controlling (programming) these applications/devices in the manner of embodiments of the present disclosure solves the technical issues of adjusting (or alerting) an application or device to the changing short-term targets of a user, so that the application/devices can monitor the user's health/fitness/finances/etc. based on timely and accurate information related to the user.

The process at step 240 then allows the user to view the long-term target progress. The user may view the progress on a web interface, such as a private web page or other electronic interface private to the user, coupled to the mobile health engine. The mobile health engine may display the user progress in a visual representation, such as a chart, table, diagram, or other such visual representation or graphics, at a graphical user interface presented on a display device. The mobile health engine may generate the visual representation based on recorded replies to text messages sent to the user, or other text message communication from the user. In some embodiments, the visual representation may be further based on other information or material (e.g., pictures or icons) provided by the user using the web interface, and based on analysis of the information or materials in regards to the long-term target and ascribed value of the user. In some embodiments, the mobile health engine may automatically generate the visual representation in a determined preferred presentation for the user (e.g., which may be most effective to the visualization of the particular user in terms of format, color, effects, etc.) based on analyzing the present long-term target of the user and neurobiological data of the user.

### Process for Changing User Actions

FIG. 2B is a sequence diagram depicting an example process for changing user actions in embodiments of the disclosure. The process starts at step 252 when the user accesses a mobile health web application executing on a mobile health engine. The user may access the mobile health web application via a web client executing on a mobile device, or any other device configured to provide web-based access (e.g., laptop, tablet, or PC). In the embodiment of FIG. 2B, the mobile health engine is comprised of a web server, an application server, and an application database. In other embodiments, the mobile health engine may be comprised additional or different components, such as voice based components (e.g., IVR device and telephony server). At step 252, when the user initiates access to the mobile health engine via a mobile device, a web request is send to the web server, and forwarded to the application server for further processing. As part of the process, the mobile health engine displays 254 a mobile health web interface on the mobile device. Using the interface, which is communicatively coupled to applications executing on the application server of the mobile health engine, the user may register and setup a long-term target 256 at the mobile health engine. The registration may require the user to specify data such as a name, username, password, phone number, email address, information regarding user's other applications and devices, or any other such information to identify the user.

The setting up of the long-term target may require the user to specify a category of action changes that align to the user's long-term target (e.g., weight loss, exercise, financial health, procrastination, smoking cessation, addiction, and such), which may be used to formulate text messages designed specifically (content, timing, etc.) based on these targets. The setting up of the long-term target may further require the user to specify in text a long-term target (e.g., “I want to lose 10 lbs.”) and an ascribed value associated with the long-term target (e.g., “so that I can have more energy to play with my kids”). In some embodiments, the setting up of the long-term target may also include setting parameter related to communicating messages (e.g., text messages) regarding the long-term target, such as the number of messages, the content of each message, the timing for sending each message, and the duration for sending the messages. For example, a text message may use particular information provided for a user in the content of the text message based upon the user's specific target category, long-term target, ascribed value, or short-term target. The long-term target and message parameters may be recorded by the application in the application database. Each message may also incorporate the user's name and a link to a website that provides additional information (e.g., health, behavior, etc.) related to the user's target. Once the user completes the registration and setup of a long-term target, the user may receive 258 a welcome message from the mobile health engine.

Beginning the following morning, the user may begin to receive three messages a day from the mobile health engine following the format of “SET”, “CHECK”, and “MONITOR” based on the transtheoretical model of change. In some embodiments, the messages may be SMS text messages generated from a Twilio application executing on the application server component of the mobile health engine, which act as alerts on a mobile device to collect current and accurate information regarding the user's short-term targets toward the long-term target. Appendix B illustrates example code to implement the SMS text message generation in PHP scripting language for a Twilio application.

Each morning, the user may receive 262 the first “SET” message prompting/alerting the user of his/her long-term target, and in some embodiments, reminding the user of the ascribed value associated with his/her long-term target. The specific time and content of the message may be based on message parameters configured by the user, configured by a behavioral professional after analyzing the configured long-term target, or automatically generated by a web application analyzing the configured long-term target and related data regarding the user. The first message may further prompt the user to “SET” their specific short-term target for the day (e.g., “I will walk for 20 minutes at lunch time”). The message may also include a link to a website (e.g., “text X to receive more information”) that provides more information on the change actions of the user. In some embodiments, the user may reply to the message with the specific short-term target, which the application server may record at the mobile health engine in the application database.

Around midday, the user may receive 264 a second “CHECK” message prompting/alerting the user to evaluate his/her current progress toward the specific short-term target. The “CHECK” message may further prompt the user to adjust the specific short-term target based on the user's current progress. The specific time and content of the message may be based on message parameters configured by the user, configured by a behavioral professional after analyzing the configured long-term target, or automatically generated by a web application analyzing the configured long-term target. The message may also include a link to a website that provides more information on the change actions of the user. In some embodiments, the user may reply to the message with an adjusted short-term target, which the application server may record at the mobile health engine in the application database.

Then, each evening, the user may receive 266 a third “MONITOR” message asking the user if his/her short-term target for the day was met. The specific time and content of the message may be based on message parameters configured by the user, configured by a behavioral professional after analyzing the configured long-term target, or automatically generated by a web application analyzing the configured long-term target. The user may respond 268 to the “MONITOR” message to confirm or deny that the short-term target for the day was met. In some embodiments, the user may respond by sending a message containing “yes” or “no,” and in other embodiments, the user may respond with a more detailed message. The message may also include a link to the member login page (e.g., https://caterpilly.com/text) to expediently view the user's dashboard to monitor progress toward the user's long-term target. The response may be received by the application executing on the application server, which may record the response in the application database. The application may further send an appropriate and specific reply to the user's response, which may provide feedback or incentives to his/her regarding the user's long-term target that support the change process. The specific time and content of the message may be based on message parameters configured by the user, configured by a behavioral professional after analyzing the configured long-term target, or automatically generated by a web application analyzing the configured long-term target.

At any time after registering, the user may access 272 the mobile health application executing on application server of the mobile health engine, which may display 274 a mobile health web interface to the user. The user may login 278 via the web interface to a private webpage (dashboard) to view his/her progress in a visual representation, such as a chart, table, diagram, or other graphics, at a graphical user interface presented on a display device. An application executing on the application server may provide the visual representation by accessing the user provided responses to the three daily messages received from the mobile health engine. The application may also analyze the user provided responses, along with the user's specified long-term target and ascribed value, and/or recent psychological/neurobiological data of the user as part of generating the visual representation. The application may automatically generate the visual representation in a determined preferred format for the user based on these analyses of the user, which provides a technical solution to the graphical user interface issue of automatically presenting data most effectively for consideration by a particular user. The web interface may also provide access to a bookstore, video library, FAQs page, blog, and member community board. In some embodiments, the mobile health application may further control/program other applications or devices to the changing short-term targets of a user (e.g., after at least one of the SET, CHECK, MONITOR messages), so that the application/devices can configure and monitor the user's health/fitness/finances/etc. based on timely and accurate targets related to the user.

### Improved Notification of Targets

FIG. 2C is a sequence diagram depicting an example process of generating improved notifications to users with respect to long-term and short-term targets of users in embodiments of the disclosure. The process starts, at step 282, by requesting, from an active server page (ASP) server, long-term targets of the user via a mobile health engine. In some embodiments, the ASP server may be replaced by any other web-based server that processes HTML pages in a scripting environment. In some embodiments, the request is made by a user via a mobile device, such as mobile phone, FitBit, or any other mobile health or fitness device, executing a web-based application. The process, at step 284, next requests, from the ASP server, short-term targets of the user via the mobile health engine. The process may request the long-term targets and short-term targets at the same time, or may request the long-term targets at one time and then request the short-term targets over time intervals, such as three times daily, or may request the long-term targets and short-term targets in any other conceivable intervals of time.

The process, at step 286, then compares the requested long-term targets against the requested short-term targets to generate an improved notification to the user with respect to the long-term and short-term targets. For example, the process analyzes the content of each long-term target in regards to each respective short-term target to determine the content and frequency of different short-term targets being selected from long-term targets of similar content or after selection of prior short-term targets of similar content. From the analysis, the process may generate improved notifications to the user, such as notifications to request the user to set or adjust a short-term target, based on determining the probability that a user will set/adjust particular types of short-term targets based on the prior selection of particular types of long-term targets or particular types of short-term targets. Then, based on determining the probability that a user will set/adjust particular short-term targets, the notifications to the user may be improved by reformulating the content of the notifications to better encourage the user towards these types of short-term targets.

The process, at step 288, further compares the requested short-term targets, requested long-term targets, and improved notification to a corpus of stored mappings of targets (long-term and short-term) linked to notifications to the user. For example, the mappings may comprise a relational database or any other structure in memory that enables storing dependencies between data objects. These stored mappings may comprise data collected over time comprising various short-term targets and long-term targets from different users of the mobile health engine. In some embodiments, the mappings of the short-term targets and long-term targets are linked to current notifications sent to prompt the user to further select short-term targets, and the mobile health engine searches or queries the mappings to determine a particular notification based on a currently requested one or more long-term and short-term targets. The current mapped notifications may have been generated in part by data programmed by a user or administrator of the mobile health engine or by a similar probabilistic analysis as step 286. From the comparing at step 288, the process may generate the improved notifications based on the stored mappings at step 290. That is, the corpus of mappings may provide the analysis of the process a larger set of data for determining the probability that a user will set/adjust particular short-term targets based on long-term targets or on prior short-term targets, and formulate a further improved content of the notifications to encourage the user toward these types of short-term targets.

Then, at step 292, the process may create a mapping of the requested long-term targets, short-term targets, and improved generated notifications and add the mapping to the corpus. As part of adding the mapping, the process may determine that the added mapping replaces one or more other mappings currently in the corpus, and remove those replaced mappings from the corpus. As such, the process may generate a smaller structured corpus that requires less memory or source code for searching or querying a particular notification based on requested long-term and short-term targets, thereby improving the operations (computation speeds and memory usage) of the mobile health engine when communicating with a user.

### Example Web Interfaces

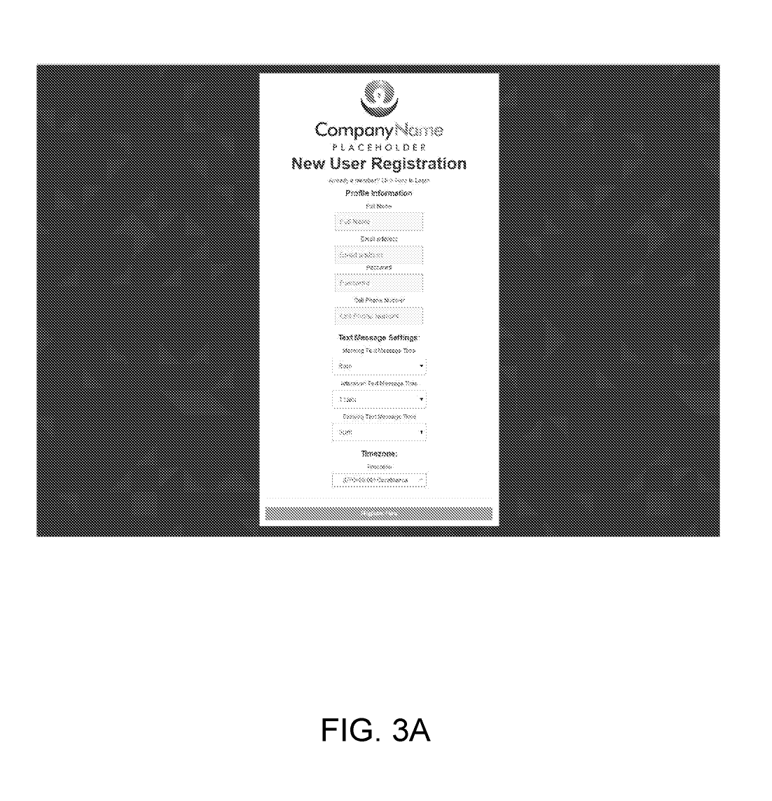

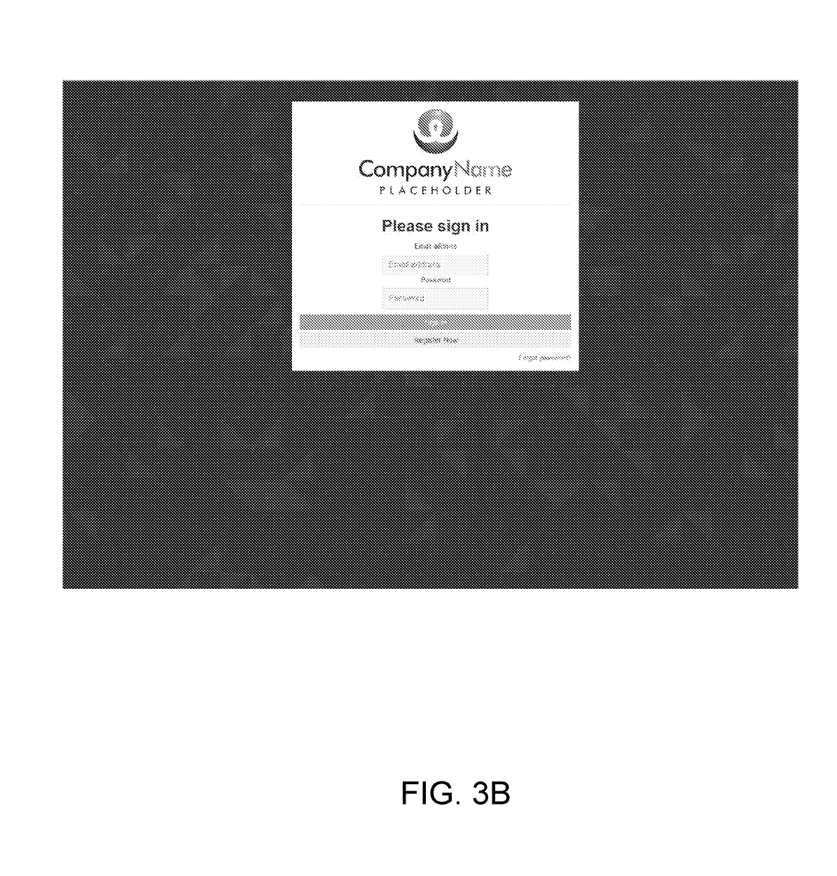

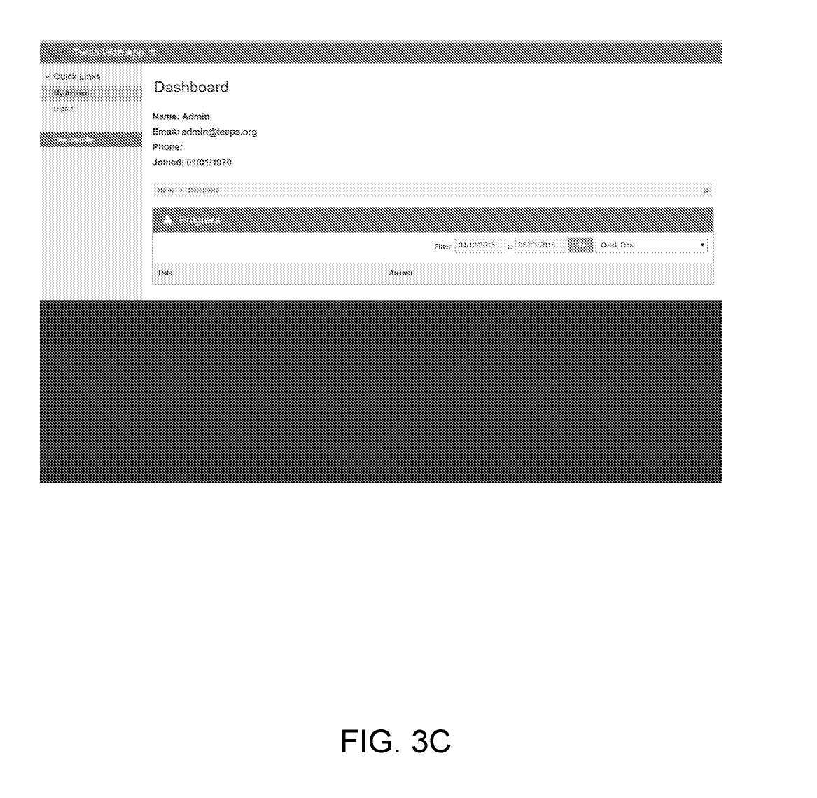

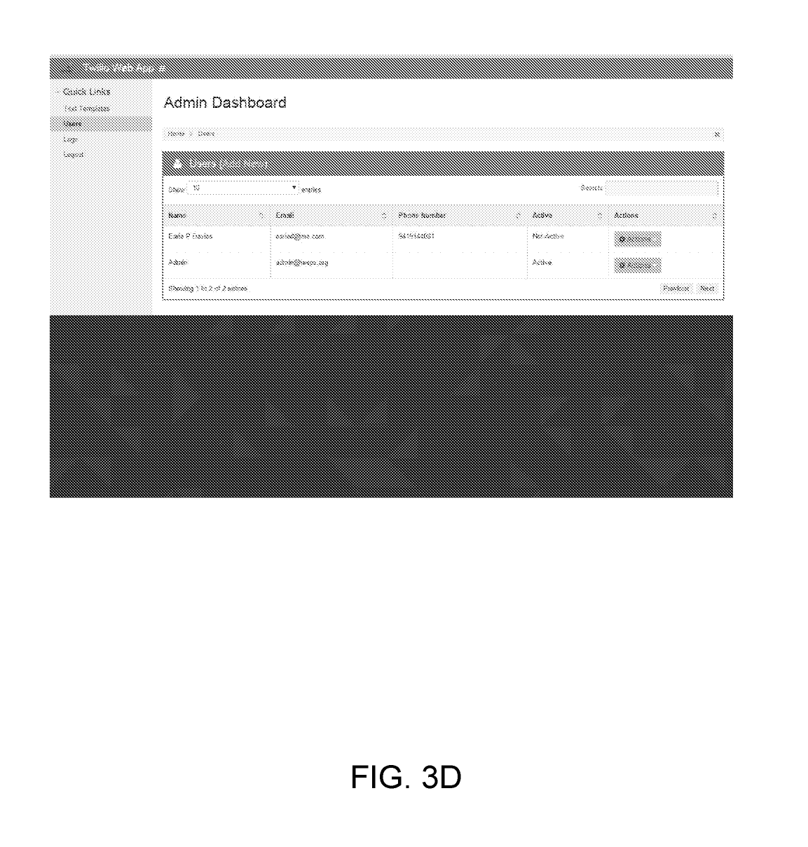

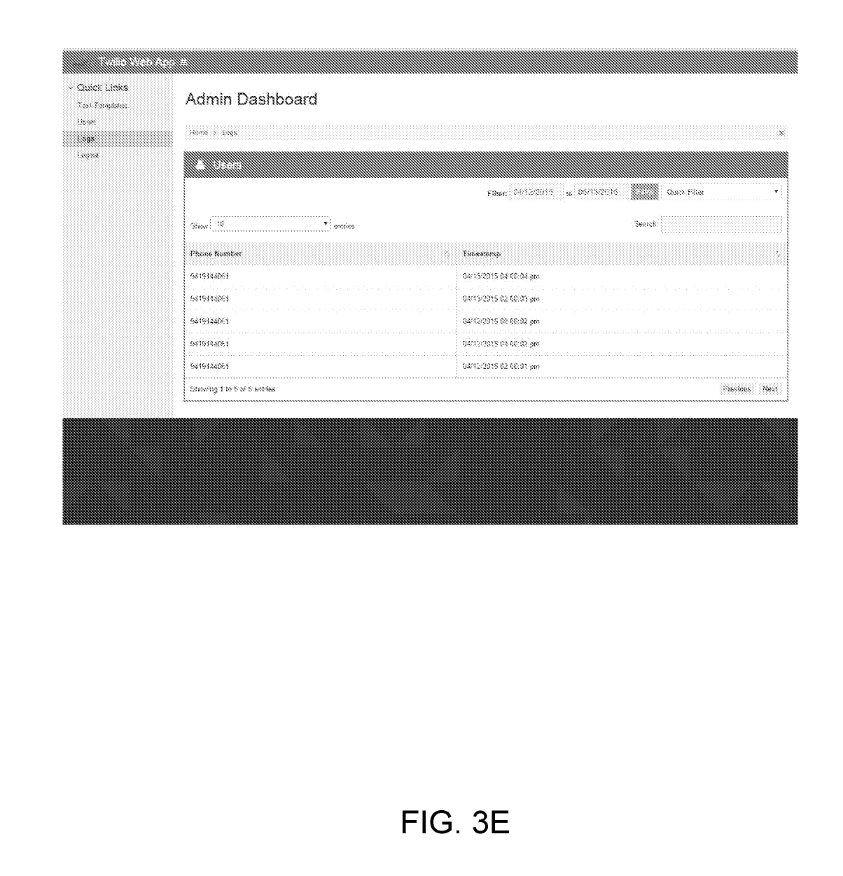

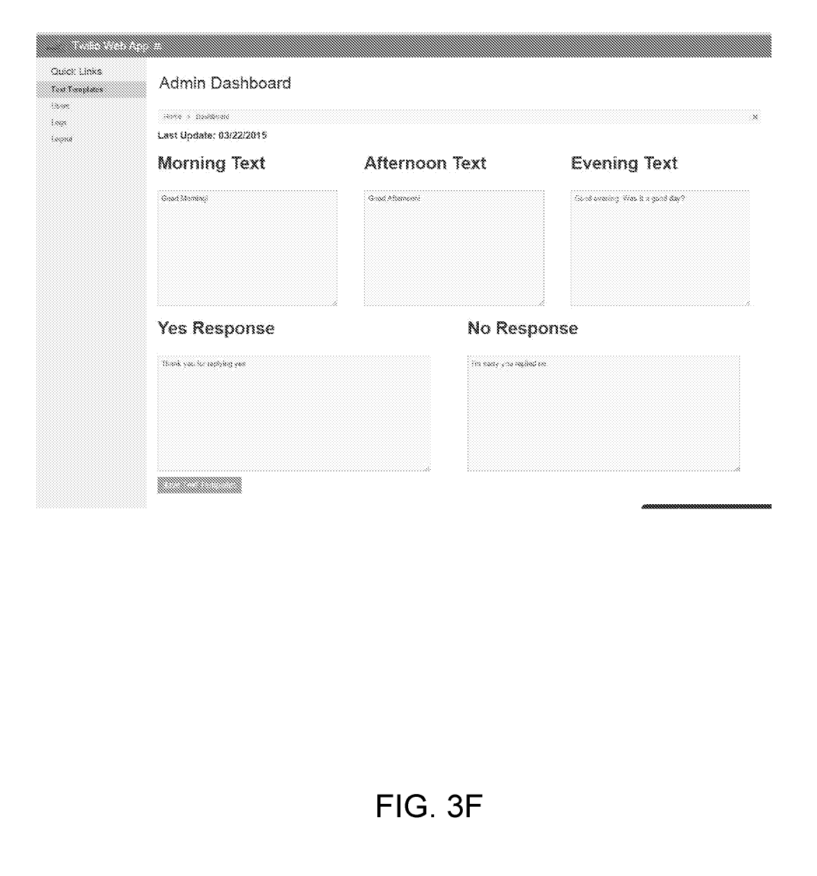

FIGS. 3A-3F illustrate example web interfaces for the mobile health system in an example embodiment of the present disclosure. The web interfaces may provide access to a user, an administrator, a privileged user (e.g., behavioral health professional), or by a combination of one or more of these individuals. FIG. 3A illustrates a web interface for a new user to register with the mobile health system/device. In the embodiment of FIG. 3A, the user must specify full name, email, address, password, cell phone number, times to receive daily text messages, and the time zone. In other embodiments, the user may specify additional or different data to register with the system. In some embodiments, similar web interfaces may be provided for a system administrator or a privileged user (e.g., behavioral health professional) to register with the mobile health system/device for the purpose of monitoring and analyzing the user's account information. Once the new user registers with the mobile health system/device, FIG. 3B illustrates a web interface for the user to sign into the system using the email address and password specified in FIG. 3A. The web interface of FIG. 3B, or a similar web interface, may be provided for a system administrator or a privileged user to sign into his/her registered account on the system for the purpose of monitoring and analyzing the user's account information.

FIGS. 3C-3F illustrate example dashboards displayed to a user, administrator, or privileged user after signing into his/her registered account. The dashboard of FIG. 3C may display user account information, such as configured name (e.g., admin), email (e.g., admin@teeps.org), phone, and date joined. The dashboard of FIG. 3C may also display progress information regarding the user meeting his/her long-term target under the Progress section. This progress information may include the user's replies to daily messages (e.g., text messages) sent to the user by the mobile health engine, or other messages sent to the mobile health engine from the user. These replies may include the user's reply to meeting his/her daily short-term targets. In some embodiments, these replies may also include the user's daily short-term targets and adjusted short-term targets. The dashboard may include a field, or other option, for the user to specify a long-term target and an ascribed value associated with the long-term target (not pictured). In these embodiments, the dashboard may also display the specified long-term target and ascribed value. Similarly, in some embodiments, the dashboard may include a field, or other option, for the user to specify message related parameters, such as the number of messages, the content of each message, the timing for sending each message, and the duration for sending the messages. In these embodiments, the dashboard may also display the specified message related parameters.

FIGS. 3D and 3E illustrate example dashboards for an administrator or privileged user (e.g., behavioral professional). The dashboard of FIG. 3D may allow the administrator or privileged user the ability to monitor and control the user accounts. The dashboard may list each user account, including user account information such as name, email, phone number, and the active status of the account. The dashboard may also list the administrator and privileged user accounts. The dashboard may provide the administrator or privileged user an option to take Actions regarding a user account. For example, for the administrator, the actions may include deactivating or deleting the account. For another example, for the privileged user, the actions may include viewing the user long-term target and progress information. The Actions may further include updating message parameters for the user based on analyzing the user long-term target and progress information. The dashboard of FIG. 3E allows the administrator or privilege user the ability to view logs generated by the mobile health engine based on user activity. The logs may be generated in response to receiving a message from the user, such as a reply to a text message generated by the system. The dashboard may identify each log by specifying the phone number from which the message was received and the timestamp at which the message was received. In some embodiments, the logs may also include other user activities, such as the user setting/updating long-term target information or message parameter information.

FIG. 3F illustrates an example dashboard for an administrator or privileged user to specify message text for messages and responses (e.g., text messages) sent to the user in example embodiments of the disclosure. Appendix A illustrates example code to implement the dashboard of FIG. 3F in PHP scripting language for a Twilio application. In some embodiments, the user may also be given access to the dashboard for specifying the message text. A privileged user, such as a behavioral professional, may specify each message based on analyzing the long-term target and progress information for a user by using the Actions option shown in FIG. 3D. In some embodiments, an application executing on the mobile health engine may automatically generate the text for the messages using methods which analyze the long-term target and progress information for the user. In other embodiments, the dashboard may allow configuration for additional messages/responses, different messages/response categories, or allow the user to customize the number and category of the messages/responses.

### Example Database Interface

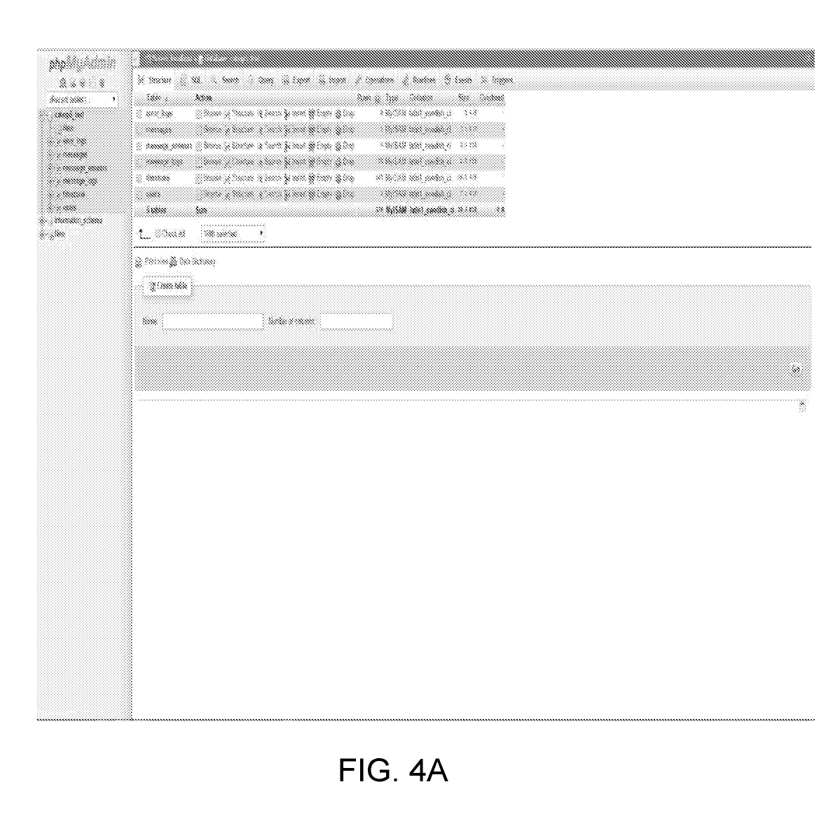

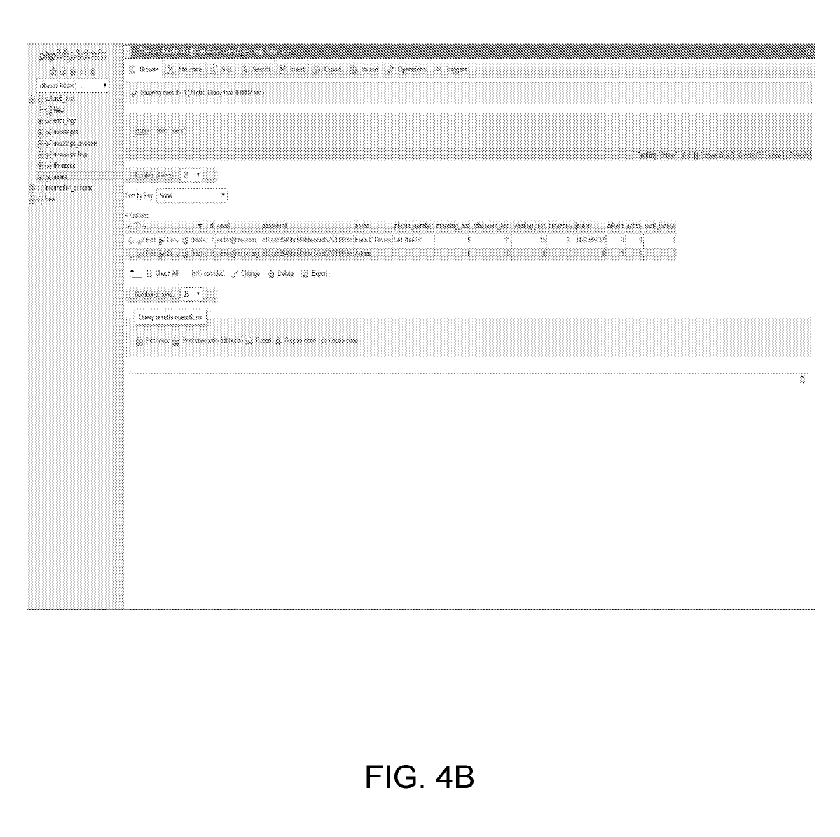

FIGS. 4A and 4B illustrate an example application database for the mobile health system in an example embodiment of the disclosure. FIG. 4A illustrates that the example application database contains various tables for managing some of the user account activity. The example database includes users and timezones tables for recording user account information. The example database also includes a message table for recording message parameters, which may be linked to the users table. The example database also includes the message_answers, message_logs, and error_logs table for recording message data regarding messages received from (or sent to) particular users. FIG. 4B illustrates the user table having fields for recording user account information, such as id, email, password, name, phone_number, morning text (i.e., morning message time), afternoon text (i.e., afternoon message time), evening_text (i.e., evening message time), timezone, joined (i.e., date joined), admin (i.e., whether administrator), active (i.e., whether account active), and sent_before (i.e., whether message sent before to the user). These fields may be populated, depending on the embodiment, based on user input, administrative input, privileged user input, or applications analyzing information recorded for a user, either in the user table or in other database tables. In other embodiments, the mobile health engine may contain additional or different databases and database tables for recording information regarding the user.

The teachings of all patents, published applications and references cited herein are incorporated by reference in their entirety.

While this disclosure has been particularly shown and described with references to example embodiments thereof, it will be understood by those skilled in the art that various changes in form and details may be made therein without departing from the scope of the disclosure encompassed by the appended claims.

```
APPENDIX A
<?php
session_start( );
require_once(dirname(_FILE_).‘/inc/config.php’);
require_once(dirname(_FILE_).‘/inc/functions.php’);
if (!isset($_SESSION[‘user_id’]) || $_SESSION[‘is_admin’] != ‘1’){
  header(“Location: index.php”);
}
include “inc/header.php”;
?>
    <div id=“navigation”>
        <div class=“container-fluid”>
            <a href=“#” id=“brand”>Twilio Web App</a>
            <a href=“#” class=“toggle-nav” rel=“tooltip” data-
placement=“bottom” title=“Toggle navigation”><i class=“icon-
reorder”></i></a>
        </div>
    </div>
    <div class=“container-fluid” id=“content”>
        <div id=“left”>
            <div class=“subnav”>
                <div class=“subnav-title”>
                    <a href=“#” class=‘toggle-subnav’><i
class=“icon-angle-down”></i><span>Quick Links</span></a>
                </div>
                <ul class=“subnav-menu”>
                    <li class=“active”>
                        <a href=“admin_dashboard.php”>Text
Templates</a>
                    </li>
                    <li>
                        <a href=“admin_users.php”>Users</a>
                    </li>
                    <li>
                        <a href=“admin_logs.php”>Logs</a>
                    </li>
                <li>
                        <a href=“logout.php”>Logout</a>
                    </li>
                </ul>
            </div>
        </div>
        <div id=“main” class=“add-margin”>
            <div class=“container-fluid”>
                <div class=“page-header”>
                    <div class=“pull-left”>
                        <h1>Admin Dashboard</h1>
                    </div>
                </div>
                <div class=“breadcrumbs”>
                    <ul>
                        <li>
                            <a href=“more-
login.html”>Home</a>
                            <i class=“icon-angle-right”></i>
                        </li>
                        <li>
                            <a href=“#”>Dashboard</a>
                        </li>
                    </ul>
                    <div class=“close-bread”>
                        <a href=“#”><i class=“icon-
remove”></i></a>
                    </div>
                </div>
            <?php
                if (isset($_POST[‘done’])){
                  $wpdb->query(“UPDATE messages SET
morning_text=‘“.addslashes($_POST[‘morning_text’]).”’,
afternoon_text=‘“.addslashes($_POST[‘afternoon_text’]).”’,
evening_text=‘“.addslashes($_POST[‘evening_text’]).”’,
yes_response=‘“.addslashes($_POST[‘yes_response’]).”’,
no_response=‘“.addslashes($_POST[‘no_response’]).”’,
last_update=‘“.time( ).”’ WHERE id=‘1’”);
                  echo ‘<div class=“alert alert-success”>Texts
Templates have been saved!</div>’;
                }
                $row = $wpdb->get_row(“SELECT * FROM messages
WHERE id=‘1’”);
                echo ‘<h4>Last Update: ’.date(‘m/d/Y’, $row-
>last_update).‘</h4>’;
            ?>
            <form action=“” method=“post”>
                <div class=“row-fluid”>
                <div class=“span4”>
                  <h2>Morning Text</h2>
                  <br />
                  <textarea class=“admin_texts”
name=“morning_text” id=“” cols=“30” rows=“10”><?php echo
stripslashes($row->morning_text); ?></textarea>
                </div>
            <div class=“span4”>
                  <h2>Afternoon Text</h2>
                  <br />
                  <textarea class=“admin_texts”
name=“afternoon_text” id=“” cols=“30” rows=“10”><?php echo
stripslashes($row->afternoon_text); ?></textarea>
              </div>
              <div class=“span4”>
                  <h2>Evening Text</h2>
                  <br />
                  <textarea class=“admin_texts”
name=“evening_text” id=“” cols=“30” rows=“10”><?php echo
stripslashes($row->evening_text); ?></textarea>
              </div>
                </div>
            <div class=“row-fluid”>
              <div class=“span6”>
                  <h2>Yes Response</h2>
                  <br />
                  <textarea class=“admin_texts”
name=“yes_response” id=“” cols=“30” rows=“10”><?php echo
stripslashes($row->yes_response); ?></textarea>
              </div>
              <div class=“span6”>
                  <h2>No Response</h2>
                  <br />
                  <textarea class=“admin_texts”
name=“no_response” id=“” cols=“30” rows=“10”><?php echo
stripslashes($row->no_response); ?></textarea>
                </div>
            </div>
            <div class=“row-fluid”>
                <div class=“span12”>
                  <input type=“submit” class=“btn btn-success”
value=“Save Text Templates” name=“done” />
                </div>
            </div>
          </form>
            </div>
      </div>
    </div> <!-- /container -->
    <?php include “inc/footer.php”; ?>
  </body>
</html>
```

```
APPENDIX B
<?php
include “../inc/config.php”;
    /* Send an SMS using Twilio. You can run this file 3 different
ways:
    *
    * - Save it as sendnotifications.php and at the command line,
run
    * php sendnotifications.php
    *
    * - Upload it to a web host and load
mywebhost.com/sendnotifications.php
    * in a web browser.
    * - Download a local server like WAMP, MAMP or XAMPP.
Point the web root
    * directory to the folder containing this file, and load
    * localhost:8888/sendnotifications.php in a web browser.
    */
    // Include the PHP Twilio library. You need to download the
library from
    // twilio.com/docs/libraries, and move it into the folder
containing this
    // file.
    require “Services/Twilio.php”;
    // Set our AccountSid and AuthToken from twilio.com/user/account
    // Instantiate a new Twilio Rest Client
    $client = new Services_Twilio(AccountSid, AuthToken);
    /* Your Twilio Number or Outgoing Caller ID */
    $from = FROM_PHONE;
    // make an associative array of server admins. Feel free to
change/add your
    // own phone number and name here.
    $all_zones = $wpdb->get_results(“SELECT * FROM timezone
ORDER BY clean_name ASC”);
    $eight = “WHERE active=‘1’ AND (id=‘0’”;
    $nine = “”;
    $ten = “”;
    $eleven = “WHERE sent_before=‘1’ AND active=‘1’ AND (id=‘0’”;
    $twelve = “”;
    $thirteen = “”;
    $fourteen = “”;
    $fifteen = “WHERE sent_before=‘1’ AND active=‘1’ AND ( id=‘0’”;
    $sixteen = “”;
    $seventeen = “”;
    $eighteen = “”;
    foreach ($all_zones as $zone) {
      date_default_timezone_set ($zone->php_name);
      $cur_hour = date(‘H’, time( ));
      switch ($cur_hour){
          case ‘08’:
              $eight .= “ OR (timezone=‘“.$zone->id.”’ AND
morning_text=‘8’)”;
          break;
          case ‘09’:
              $nine .= “ OR (timezone=‘“.Szone->id.”’ AND
morning_text=‘9’)”;
          break;
          case ‘10’:
              $ten .= “ OR (timezone=‘“.$zone->id.”’ AND
morning_text=‘10’)”;
          break;
          case ‘11’:
              $eleven .= “ OR (timezone=‘“.$zone->id.”’ AND
afternoon_text=‘11’)”;
          break;
          case ‘12’:
              $twelve .= “ OR (timezone=‘“.$zone->id.”’ AND
afternoon_text=‘12’)”;
          break;
          case ‘13’:
              $thirteen .= “ OR (timezone=‘“.$zone->id.”’ AND
afternoon_text=‘13’)”;
          break;
          case ‘14’:
              $fourteen .= “ OR (timezone=‘“.$zone->id.”’ AND
afternoon_text=‘14’)”;
          break;
          case ‘15’:
              $fifteen .= “ OR (timezone=‘“.$zone->id.”’ AND
evening_text=‘15’)”;
          break;
          case ‘16’:
              $sixteen .= “ OR (timezone=‘“.$zone->id.”’ AND
evening_text=‘16’)”;
          break;
          case ‘17’:
              $seventeen .= “ OR (timezone=‘“.$zone->id.”’ AND
evening_text=‘17’)”;
          break;
          case ‘18’:
              $eighteen .= “ OR (timezone=‘“.$zone->id.”’ AND
evening_text=‘18’)”;
          break;
      }
      //echo date(‘H’, time( )).‘ - ’.$zone->php_name.‘<br />’;
    }
      $morning_recipients = $wpdb->get_results (“SELECT
phone_number, id FROM users “.$eight.$nine.$ten.”)”);
      $afternoon_recipients = $wpdb->get_results (“SELECT
phone_number, id FROM users
“.$eleven.$twelve.$thirteen.$fourteen.”)”);
      $evening_recipients = $wpdb->get_results (“SELECT
    phone_number,
id FROM users “.$fifteen.$sixteen.$seventeen.$eighteen.”)”);
      $message = $wpdb->get_row(“SELECT * FROM messages
WHERE id=‘1’”);
      echo “SELECT phone_number, id FROM users
“.$eleven.$twelve.$thirteen.$fourteen.”)”;
      date_default_timezone_set (‘America/New_York’);
    foreach ($morning_recipients as $recipient) {
    try {
          $message = $client->account->messages->create(array(
              “From” => $from,
              “To” => ‘+1’.$recipient->phone_number,
              “Body” => stripslashes($message->morning_text),
          ));
          $wpdb->query(“INSERT INTO message_logs SET
user_id=‘“.$recipient->id.”’, sent=‘“.time( ).”’”);
          $wpdb->query(“UPDATE users SET sent_before=‘1’
WHERE id=‘“.$recipient->id.”’”);
      } catch (Services_Twilio_RestException $e) {
          global $wpdb;
          $wpdb->query(“INSERT INTO error_logs SET
phone_number=‘“.$recipient->phone_number.”’, stamp=‘“.time( )”’,
error=‘“.addslashes($e->getMessage( )).”’”);
          echo $e->getMessage( );
      }
    }
    foreach ($afternoon_recipients as $recipient) {
    try {
          $message = $client->account->messages->create(array(
              “From” => $from,
              “To” => ‘+1’.$recipient->phone_number,
              “Body” => stripslashes($message->afternoon_text),
          ));
          $wpdb->query(“INSERT INTO message_logs SET
user_id=‘“.$recipient->id.”’, sent=‘“.time( ).”’”);
      } catch (Services_Twilio_RestException $e) {
          global $wpdb;
          $wpdb->query(“INSERT INTO error_logs SET
phone_number=‘“.$recipient->phone_number.”’, stamp=‘“.time( ).”’,
error=‘“.addslashes($e->getMessage( )).”’”);
          echo $e->getMessage( );
      }
    }
    foreach ($evening_recipients as $recipient) {
    try {
          $message = $client->account->messages->create(array(
              “From” => $from,
              “To” => ‘+1’.$recipient->phone_number,
              “Body” => stripslashes($message->evening_text),
          ));
          $wpdb->query(“INSERT INTO message_logs SET
user_id=‘“.$recipient->id.”’, sent=‘“.time( ).”’”);
      } catch (Services_Twilio_RestException $e) {
          global $wpdb;
          $wpdb->query(“INSERT INTO error_logs SET
phone_number=‘“.$recipient->phone_number.”’, stamp=‘“.time( ).”’,
error=‘“.addslashes($e->getMessage( )).”’”);
          echo $e->getMessage( );
      }
    }
?>
```

What is claimed is:

1. A mobile health system for changing an action of a user, the mobile health system comprising:
a service client configured to input a long-term target and an ascribed value associated with the long-term target for changing the action of the user;
a mobile client configured to display and exchange messages based on the long-term target and the ascribed value; and
a mobile health engine coupled to the service client and the mobile client, the mobile health engine configured to:
record the long-term target and the ascribed value input from the service client;
send a plurality of messages over a period of time, wherein content of each of the plurality of messages is generated based on the long-term target and the ascribed value, and for each interval of the period of time, the sending includes at least:
sending a first message to the mobile client for alerting the user to set a specific short-term target for the given interval based on the long-term target and the ascribed value,
sending a second message to the mobile client for alerting the user to adjust the specific short-term target for the given interval, wherein the user adjusts the specific short-term target based on evaluating current progress toward the specific short-term target,
sending a third message to the mobile client for inquiring whether the adjusted short-term target is met by the user for the given interval, wherein the mobile client sends a reply to confirm or deny the adjusted short-term target being met by the user, and
receiving the adjusted short-term target of the user and confirm or deny reply, via the mobile health engine, for visual representation on a graphical user interface.

2. The mobile health system of claim 1, wherein the message is at least one of a text message, a voice message, and an email message.

3. The mobile health system of claim 1, the mobile health engine comprising at least one of a web server, an application server, a database server, and an application database.

4. The mobile health system of claim 1, the mobile health engine comprising an interactive voice response (IVR) device and a telephony server.

5. The mobile health system of claim 1, the service client comprising at least one of a web client and a voice client.

6. The mobile health system of claim 1, wherein the interval is a day.

7. The mobile health system of claim 1, wherein the mobile health engine records the reply for each interval.

8. The mobile health system of claim 7, wherein mobile health engine is further configured to at least one of: (i) generate the visual representation based on the recorded reply for each interval of the period of time and (ii) display the visual representation on an interface private to the user.

9. The mobile health system of claim 8, further comprising programming at least one of a health related application and a health related device based on the timing and context of text messages setting the short-term target and adjusting the short-term target.

10. The mobile health system of claim 1, wherein the long-term target is based on at least one of weight loss, sedentary lifestyle, stress management, procrastination, smoking cessation, substance dependence, and medication adherence.

11. The mobile health system of claim 1, wherein the content is generated using principles of human psychology, behavioral science, and neuroscience.

12. The mobile health system of claim 1, wherein timing of each of the plurality of messages is determined based on the long-term target and the ascribed value.

13. A computer-implemented method for changing an action of a user, the method comprising:
recording a long-term target and an ascribed value associated with the long-term target for changing the action of the user; and
sending a plurality of messages sent over a period of time, wherein content of each of the plurality of messages is generated based on the long-term target and the ascribed value, and for each interval of the period of time, sending includes at least:
sending a first message to request the user to set a specific short-term target for the given interval based on the long-term target and ascribed value,
sending a second message to request the user to adjust the specific short-term target for the given interval, wherein the user adjusts the specific short-term target based on evaluating current progress toward the specific short-term target,
sending a third message to inquire whether the adjusted short-term target is met by the user for the given interval, wherein replying to confirm or deny the adjusted short-term target being met by the user, and
receiving the adjusted short-term target of the user and confirm or deny reply, via the mobile health engine, for visual representation on a graphical user interface.

14. The method of claim 13, wherein the message is at least one of a text message, a voice message, and an email message.

15. The method of claim 13, wherein the interval is a day, and the mobile health engine records the reply for each interval of the period of time.

16. The method of claim 15, wherein the visual representation is at least one of (i) generated based on the recorded reply for each interval and (ii) displayed on an interface private to the user.

17. The method of claim 13, further comprising programming related at least one of a health related application and a health related device based on the timing and context of text messages setting the short-term target and adjusting the short-term target.

18. The method of claim 13, wherein the long-term target is based on at least one of weight loss, sedentary lifestyle, stress management, procrastination, smoking cessation, substance dependence, and medication adherence.

19. The method of claim 13, wherein the content is generated using principles of human psychology, behavioral science, and neuroscience.

20. The method of claim 13, wherein timing of each of the plurality of messages is determined based on the long-term target and the ascribed value
